(19) United States
(12) Patent Application Publication
(10) Pub. No.: US 2023/0408287 A1
(43) Pub. Date: Dec. 21, 2023

(54) METHOD AND APPARATUS FOR COORDINATING HISTORY WITH GEOGRAPHICAL COORDINATES

(71) Applicants: Mark CONRON, Sheffield Lake, OH (US); Daniel A. THOMSON, Copley, OH (US)

(72) Inventors: Mark CONRON, Sheffield Lake, OH (US); Daniel A. THOMSON, Copley, OH (US)

(21) Appl. No.: 18/335,601

(22) Filed: Jun. 15, 2023

Related U.S. Application Data
(60) Provisional application No. 63/366,505, filed on Jun. 16, 2022.

(51) Int. Cl. G01C 21/36; B60W 60/00; G06Q 20/04

(52) U.S. Cl. CPC G01C 21/3679; B60W 60/00256; G06Q 20/045; B60W 2756/10

(57) ABSTRACT

A non-transitory computer readable storage device storing computer executable instructions that when executed by a computer controls the computer to perform a method for coordinating history with geographical coordinates includes providing an electronic database, wherein the electronic database has information tied to specific geographic coordinates, accessing a global navigation satellite system, the global navigation satellite system providing at least one geographic coordinate of an associated user, searching the electronic database for matches of the at least one geographic coordinate of the associated user with a nearby geographic coordinate in the electronic database, wherein the searching of the electronic database is automatically continuous, providing a list of the matches, and providing playback options for the associated user, wherein the playback options are chosen from the group consisting of audio files, video files, text files, and image files.

This application claims priority to provisional patent application, Ser. No. 63/366,505, filed Jun. 16, 2022, the contents of which are incorporated herein by reference.

### I. BACKGROUND

The present subject matter is a method and apparatus for coordinating history with geographical coordinates.

Millions of miles are driven every year along the world's road system. During this time, travelers have utilized numerous devices and ideas to pass the time. People have used games, music, movies, and other electronic devices in order to entertain themselves on long drives.

During a road trip, millions of people drive past various points of interest without having any idea the points of interest are there. Some may wonder if something interesting happened in a given location.

Businesses near points of interest are always looking for additional ways to direct business to their establishments.

It remains desirable to provide a system to provide drivers with information about specific locations as they drive past.

### II. SUMMARY

In accordance with one aspect of the present subject matter, the vehicle occupants can electronically receive a narrated travelogue coordinated by GPS to the vehicle's location.

Still other benefits and advantages of the present subject matter will become apparent to those skilled in the art to which it pertains upon a reading and understanding of the following detailed specification.

### III. BRIEF DESCRIPTION OF THE DRAWINGS

The present subject matter may take physical form in certain parts and arrangement of parts, aspects of which will be described in detail in this specification and illustrated in the accompanying drawings which form a part hereof and wherein:

FIG. 1 is a top view of a GPS device;

FIG. 2 is a front view of a vehicle with a GPS locator; and,

FIG. 3 is a perspective view of a map showing various road routes.

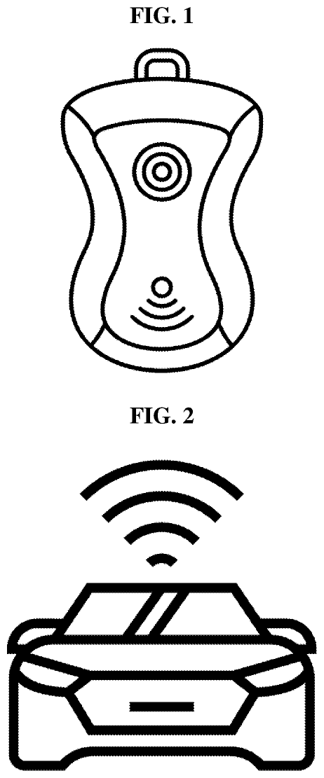

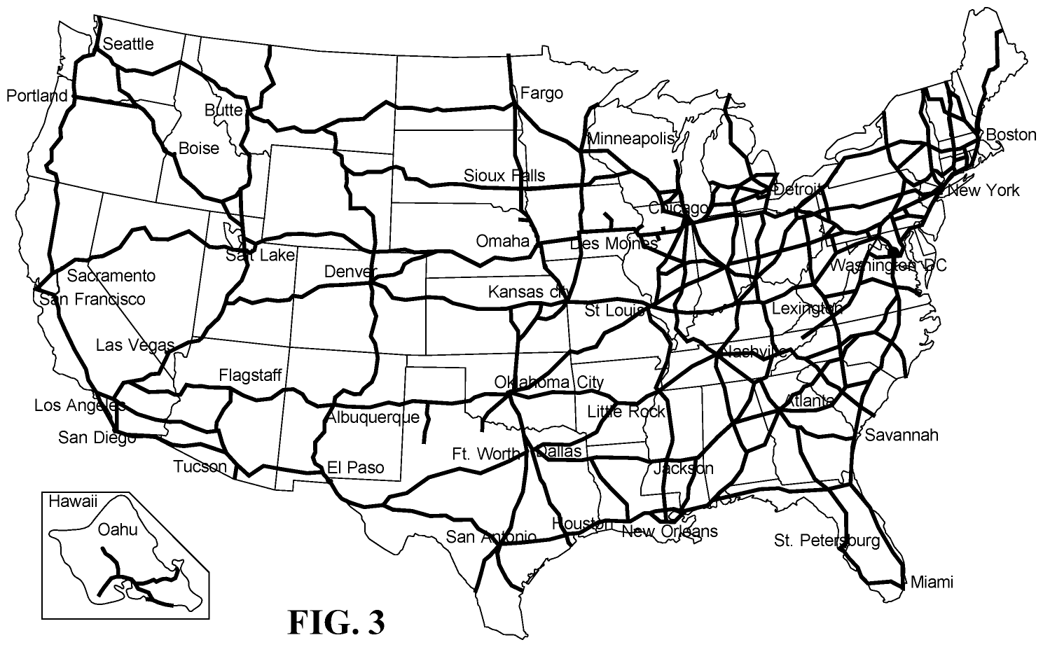

### IV. DETAILED DESCRIPTION

Referring now to the drawings wherein the showings are for purposes of illustrating aspects of the present teaching only and not for purposes of limiting the same, and wherein like reference numerals are understood to refer to like components, provided is a method and apparatus for coordinating history with geographical coordinates.

In accordance with the FIGURES, a vehicle can be equipped with a GPS locator, or some other means of determining location, and an electronic receiver for receiving electronic data, such as a mobile phone, a radio, a satellite radio, a shortwave radio, a computer, or other mobile device. Information regarding a particular area's location will be available via a non-transitory computer readable medium (non-transitory CRM), which will be tied to geographical location. As a vehicle passes through a particular geographic region, the non-transitory CRM receives GPS location from the GPS locator and then provides the audio or video message associated with that particular location. The non-transitory CRM can be set up in multiple languages, and multiple different preferences. Preferences can be related to history, sports, famous events, museums, tourist attractions, or any other item of interest for a traveler. In one aspect of the present teachings, the non-transitory CRM could be made available prior to a trip commencing, with all the various attractions preloaded based on a predetermined route entered into the non-transitory CRM.

With continuing reference to the FIGURES, one aspect of the present teachings, the non-transitory CRM could be made available via various app stores, could be streamed live online, or could be preloaded onto an electronic device. The non-transitory CRM could even come preloaded in a vehicle, connecting with a vehicle's existing navigation system.

In one aspect of the present teachings, the non-transitory CRM provides a verbal, historical narrative, supplied through speakers or a vehicle's audio system, on a county-by-county basis as the driver of the vehicle travels down a road. The non-transitory CRM will pool information regarding each county's history from a variety of sources available on the Internet and provide that information through voice recordings, dependent on which county the driver happens to be in. The application will also provide the users options as to who is narrating their drive through the counties. It is also understood that the non-transitory CRM will provide maps and pictures of the area surrounding the driver within set distance circumference. Along with the specific area's historical narrative, it is understood the non-transitory CRM will also provide information regarding businesses, points of interest, and other attractions in the nearby area through the sale of advertisements to the owners of those attractions. Lastly, it is understood the non-transitory CRM can come as a free version with occasional advertisements, or as a monthly paid subscription with no advertisements. As such, the non-transitory CRM enhances the performance and efficiency of the electronic device by enabling the device to retrieve information based on its location and automatically deliver historical, tour-guide voice recordings based on that location information.

In one aspect of the present teachings, the information mentioned above could be available via a touchscreen device with various user options. It is to be understood that any electronic user interface could be used.

In another aspect of the present teachings, the system retrieves GPS coordinate information from the smartphone (or other electronic device) and uses it as a method for playing historical information of the immediate surrounding area through vehicle speakers. The non-transitory CRM utilizes this information to automatically begin the playback when the driver comes within the vicinity of points of interest and requires no input from the driver to begin playing. The non-transitory CRM could even receive voice commands should a driver wish to instruct the non-transitory CRM to pause, continue, or redirect course so that the driver can operate the vehicle safely. The non-transitory CRM could also provide for a recording option to allow later playback. In another aspect of the present teachings, the non-transitory CRM could also allow either written or verbal notes to be added to the information provided.

In another aspect of the present teachings, the system utilizes the GPS and historical information as a method for preemptively asking the driver over the vehicle speakers if he would like to redirect his course to go see a nearby point of interest, allowing the user notice before passing the point of interest while on the road. In addition, a self-driving car could be pre-programmed to change route based on the information provided.

In another aspect of the present teachings, the system retrieves route information from the GPS non-transitory CRM as a method for providing historical points of interest along the route, giving the driver the option of selecting points of interest to stop at along the route, and planning ahead which detours will be made in the vehicle navigation system.

In another aspect of the present teachings, the system utilizes its GPS information as a method for providing historical information based on the points of interest in the users most immediate vicinity, rather than just what county they are in, so what is within the driver's sight is being discussed automatically over the vehicle speakers while driving down the road.

Non-limiting aspects have been described, hereinabove. It will be apparent to those skilled in the art that the above methods and apparatuses may incorporate changes and modifications without departing from the general scope of the present subject matter. It is intended to include all such modifications and alterations in so far as they come within the scope of the appended claims or the equivalents thereof.

I/We claim:

1. A non-transitory computer readable storage device storing computer executable instructions that when executed by a computer controls the computer to perform a method for coordinating history with geographical coordinates, the method comprising:
providing an electronic database, wherein the electronic database has information tied to specific geographic coordinates;
accessing a global navigation satellite system, the global navigation satellite system providing at least one geographic coordinate of an associated user;
searching the electronic database for matches of the at least one geographic coordinate of the associated user with a nearby geographic coordinate in the electronic database, wherein the searching of the electronic database is automatically continuous;
providing a list of the matches; and
providing playback options for the associated user, wherein the playback options are chosen from the group consisting of audio files, video files, text files, and image files.

2. The method of claim 1, wherein the method further comprises:
entering a route map of a route chosen by the associated user into the electronic database;
automatically matching the information tied to specific geographic coordinates with the geographic coordinates along the route; and
automatically displaying at least one of the playback options when the associated user reaches the geographic coordinates associated with the information.

3. The method of claim 1, wherein the playback options are displayed using at least of the group consisting of a touchscreen, audio speakers, an electronic mobile device, Bluetooth speakers, text to speech, video player, and electronic text.

4. The method of claim 3, wherein the information is chosen from the group consisting of historical information, sports information, geological information, biological information, trivia information, topographical information, biographical information, military information, and chronological information.

5. The method of claim 2, wherein the method further comprises:
automatically creating an updated route map based on the matches and the information.

6. The method of claim 5, wherein the method further comprises:
delivering instructions to a self-driving vehicle to automatically drive to a geographic coordinate based on the matches.

7. The method of claim 6, wherein the method further comprises:
automatically sharing the information with at least one other associated user.

8. The method of claim 7, wherein the method further comprises:
automatically purchasing tickets to a location having an entrance fee, based upon the matches and the information.

9. An electronic device containing non-transitory computer readable storage device storing computer executable instructions that when executed by a computer controls the computer to perform a method for coordinating history with geographical coordinates, the device comprising:
an electronic database, wherein the electronic database has information tied to specific geographic coordinates;
a global navigation satellite system, the global navigation satellite system providing at least one geographic coordinate of an associated user;
executable instructions for searching the electronic database for matches of the at least one geographic coordinate of the associated user with a nearby geographic coordinate in the electronic database, wherein the searching of the electronic database is automatically continuous;
a list of the matches; and
playback options for the associated user, wherein the playback options are chosen from the group consisting of audio files, video files, text files, and image files.

10. The device of claim 9, wherein the device further comprises:
a route map of a route chosen by the associated user into the electronic database, wherein the information tied to specific geographic coordinates is automatically matched with the geographic coordinates along the route; and
automatically displaying at least one of the playback options when the associated user reaches the geographic coordinates associated with the information.

11. The device of claim 10, wherein the playback options are displayed using at least of the group consisting of a touchscreen, audio speakers, an electronic mobile device, Bluetooth speakers, text to speech, video player, and electronic text.

12. The device of claim 3, wherein the information is chosen from the group consisting of historical information, sports information, geological information, biological information, trivia information, topographical information, biographical information, military information, and chronological information.

13. The device of claim 10, wherein the device further comprises:
executable instructions for automatically creating an updated route map based on the matches and the information.

14. The device of claim 13, wherein the device further comprises:
executable instructions for delivering instructions to a self-driving vehicle to automatically drive to a geographic coordinate based on the matches.

15. The device of claim 14, wherein the device further comprises:
executable instructions for automatically sharing the information with at least one other associated user.

16. The device of claim 15, wherein the device further comprises:
executable instructions for automatically purchasing tickets to a location having an entrance fee, based upon the matches and the information.
